(19) United States
(12) Patent Application Publication
(10) Pub. No.: US 2023/0368317 A1
(43) Pub. Date: Nov. 16, 2023

(54) SYSTEM AND METHOD FOR GENERATION OF ALPHANUMERIC CODES

(71) Applicant: EYE INSIDE LLC, Falls Church, VA (US)

(72) Inventors: Daniyal Ghanbari, Falls Church, VA (US); Duy Nhan Nguyen, Centreville, VA (US); Abdolkhaledgh Rahmani, Fairfax, VA (US)

(21) Appl. No.: 18/196,033

(22) Filed: May 11, 2023

Related U.S. Application Data
(60) Provisional application No. 63/340,747, filed on May 11, 2022.

(51) Int. Cl. G06Q 50/16

(52) U.S. Cl. CPC G06Q 50/163

(57) ABSTRACT

The present disclosure is generally directed to alphanumeric codes that can be used to display and retrieve information. Specifically disclosed herein is a method that includes displaying a visual display that has (i) a four-character alphanumeric code, where the first and third characters are alphabetical letters and the second and fourth characters are numerical digits, and (ii) one or more products or services associated with the code, generating, by at least one processor, a graphical user interface (GUI) that prompts a user to enter the code, transmitting, by the at least one processor, the GUI to the user, receiving, by the at least one processor, the code, retrieving, by the at least one processor, information from a database relating to the one or more products or services, and transmitting, by the at least one processor, the information to the user.

### CROSS-REFERENCE TO RELATED APPLICATION

This application claims priority to U.S. Provisional Application No. 63/340,747, filed May 11, 2022, which is hereby incorporated by reference in its entirety.

### FIELD

The application relates generally to alphanumeric codes that are associated with one or more items of information. In particular, the application relates to the use of alphanumeric codes on a display or sign in order to convey the one or more items of information to a viewer of the display or sign.

### BACKGROUND

Signs or other displays are often used to convey information for advertising or marketing purposes, including billboards or other similar displays. Additionally, signs are frequently used in the buying, selling, or leasing of real estate. Generally, such signs and displays provide information about the product or service, as well as contact information about an individual (e.g., a salesman, real estate agent, or corporate point of contact) that may be able to provide further information about the product or service to a prospective consumer.

With respect to the non-limiting example of selling, leasing, or otherwise marketing residential or commercial real estate, signage is often used to display information about the specific property being marketed. Such signage often includes information about the property (e.g., size, location, a picture of the property, and the like) and contact information for a realtor or real estate agent. However, a viewer of the sign must remember specific information contained on the sign in order to express interest in the property being marketed. In many situations, the viewer only has a relatively brief moment of time to view and remember the information on the sign, such as, for example, if the viewer is driving past the sign in a vehicle.

These issues are not solely limited to marketing real estate. Similar issues exist with respect to remembering information on signs used for advertising or marketing other products or services. Prospective consumers must remember or write down contact information (e.g., telephone number, e-mail address, and the like) or details about the product or service being advertised for future use.

As a result, signs and displays often contain a large amount of information that is hard for a prospective consumer to remember, especially if that consumer is viewing the display for only a short period of time, such as when driving past a billboard or real estate sign.

Given the foregoing, there exists a significant need for alphanumeric codes that are easier for a viewer to remember so that the viewer can use that code to obtain information, such as, for instance, advertising or marketing information (e.g., information on the buying or selling of real estate).

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description.

In an example, an alphanumeric code is disclosed that can be associated with one or more items of information. The code may be placed on a sign or other display and used to convey the one or more items of information to a viewer viewing the code and/or display. The one or more items of information may include, for instance, advertising or marketing information related to a good and/or service.

In at least one aspect, the alphanumeric code can be a string of between four to six characters that enables a viewer of the code to remember it easily. In at least a further aspect, the code is a string of four characters having alternating letters and numerical digits (e.g., letter-numerical digit-letter-numerical digit). Non-limiting examples include, for instance, A1B3, H7F2, and the like.

In a non-limiting example, the aforementioned display may be a sign used to convey information for the selling or leasing of real estate. A viewer of the display that is interested in the specific property can use the code shown on the display to obtain additional information on the property.

In one example, a viewer of a display may enter the alphanumeric code into a website or mobile application that sends a request to at least one server computing device, resulting in the generation and/or display of information that has been associated with the code. This website and/or mobile application may be owned and/or operated by an individual or company responsible for advertising or marketing the good and/or service shown on the display. When a viewer of the display accesses the website, the viewer can enter the alphanumeric code to retrieve additional information about the good and/or service advertised or marketed on the display.

In another example, a method is disclosed generating one or more alphanumeric codes and using such codes on a display. The method comprises generating an alphanumeric code, which may be any alphanumeric code described herein, associating the code with one or more items of information, and generating a display that includes the alphanumeric code.

In at least one example, a non-transitory computer-readable storage medium is disclosed, having instructions stored thereon that, when executed by a computing device, cause the computing device to perform operations, the operations including transmitting a graphical user interface (GUI) configured to permit a user to (i) enter information relating to a parcel of real property, and (ii) initiate a search of a database to find a property of interest, receiving the information relating to the parcel of real property: generating a first alphanumeric code, associating the alphanumeric code with the parcel of real property, and storing the alphanumeric code and the information in the database, receiving the user-initiated search of the database: receiving a second alphanumeric code associated with the property of interest, searching the database for the second alphanumeric code, retrieving property information related to the property of interest, and transmitting the property information to the user.

The aforementioned first alphanumeric code and the second alphanumeric code can each include at least four characters. Additionally, both (i) a first character in the at least four characters and (ii) a third character in the at least four characters can be alphabetical letters. Further, both (i) a second character in the at least four characters and (ii) a fourth character in the at least four characters are numerical digits.

In another example, a non-transitory computer-readable storage medium is disclosed, having instructions stored thereon that, when executed by a computing device, cause the computing device to perform operations, the operations including transmitting a GUI configured to permit a user to enter (i) property information relating to a parcel of real property, (ii) personal information relating to the user, and (iii) the user's billing information, receiving the property information relating to the parcel of real property, the personal information, and the user's billing information, generating an account for the user, the account including the property information, the personal information, and the billing information, generating an alphanumeric code, associating the alphanumeric code with the parcel of real property, and storing the alphanumeric code and the property information in a database.

The aforementioned alphanumeric code can have four characters. Additionally, both (i) the first character in the four characters and (ii) the third character in the four characters are alphabetical letters. Further, both (i) the second character in the four characters and (ii) the fourth character in the four characters are numerical digits.

In an additional example, a non-transitory computer-readable storage medium is disclosed, having instructions stored thereon that, when executed by a computing device, cause the computing device to perform operations, the operations including transmitting a GUI configured to permit a user to search a database, the database including a plurality of alphanumeric codes and information on a plurality of parcels of real property, wherein each of the plurality of alphanumeric codes is uniquely associated with one of the plurality of parcels of real property, receiving a first alphanumeric code entered by the user, retrieving the first alphanumeric code in the plurality of alphanumeric codes, retrieving a first parcel of real property in the plurality of parcels that is associated with the first alphanumeric code, and transmitting, by the GUI, information on the first parcel of real property.

Each alphanumeric code in the plurality of alphanumeric codes can have four characters. Additionally, both (i) the first character in the four characters and (ii) the third character in the four characters are alphabetical letters. Further, both (i) the second character in the four characters and (ii) the fourth character in the four characters are numerical digits.

In a further example, a method for displaying and retrieving information is disclosed. The method includes displaying a visual display that includes (i) an alphanumeric code having a first through a fourth character, the first and the third characters being alphabetical letters, and the second and the fourth characters being numerical digits, and (ii) one or more products or services associated with the alphanumeric code, generating, by at least one processor, a GUI that prompts a user to enter the alphanumeric code, transmitting, by the at least one processor, the GUI to the user, receiving, by the at least one processor, the alphanumeric code, retrieving, by the at least one processor, information from a database relating to the one or more products or services associated with the alphanumeric code, and transmitting, by the at least one processor, the information to the user.

These and further and other objects and features of the invention are apparent in the disclosure, which includes the above and ongoing written specification, as well as the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a diagram of a display containing an alphanumeric code, according to at least one example of the present disclosure.

FIG. 2 is a diagram of a further display containing an alphanumeric code, according to at least one example of the present disclosure.

FIG. 3 is a block diagram of a computing system for operating a website and searching for an alphanumeric code, according to at least one example of the present disclosure.

FIG. 4 is a block diagram of a computing device, according to at least one example of the present disclosure.

FIG. 5 is a block diagram of a method for generating alphanumeric codes and using them on displays, according to at least one example of the present disclosure.

FIG. 6 is a block diagram of a system architecture of a website and/or mobile application, according to at least one example of the present disclosure.

FIG. 7 is a block diagram for interacting with and/or using a website and/or mobile application, according to at least one example of the present disclosure.

FIG. 8 is a block diagram of a customer data process, a multi-factor authentication process, and an employee login process, each according to at least one example of the present disclosure.

FIG. 9 is a block diagram of a user process when the user accesses the website and/or mobile application, according to at least one example of the present disclosure.

FIG. 10 is a diagram of an entity relationship model, according to at least one example of the present disclosure.

FIG. 11 is a block diagram of a further method for generating alphanumeric codes, according to at least one example of the present disclosure.

FIG. 12 is a block diagram of a method for obtaining one or more properties that are nearest to a user and displaying the one or more properties to the user using one or more alphanumeric codes, according to at least one example of the present disclosure.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

In general, the word “instructions,” as used herein, refers to logic embodied in hardware or firmware, or to a collection of software units, possibly having entry and exit points, written in a programming language, such as, but not limited to, Python, R, Rust, Go, SWIFT, Objective-C, Java, JavaScript, Lua, C, C++, or C #. A software unit may be compiled and linked into an executable program, installed in a dynamic link library, or may be written in an interpreted programming language such as, but not limited to, Python, R, Ruby, JavaScript, or Perl. It will be appreciated that software units may be callable from other units or from themselves, and/or may be invoked in response to detected events or interrupts. Software units configured for execution on computing devices by their hardware processor(s) may be provided on a computer readable medium, such as a compact disc, digital video disc, flash drive, magnetic disc, or any other tangible medium, or as a digital download (and may be originally stored in a compressed or installable format that requires installation, decompression or decryption prior to execution).

Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. Generally, the instructions described herein refer to logical modules that may be combined with other modules or divided into sub-modules despite their physical organization or storage. As used herein, the term “computer” is used in accordance with the full breadth of the term as understood by persons of ordinary skill in the art and includes, without limitation, desktop computers, laptop computers, tablets, servers, mainframe computers, smartphones, handheld computing devices, and the like.

In this disclosure, references are made to users performing certain steps or carrying out certain actions with their client computing devices/platforms. In general, such users and their computing devices are conceptually interchangeable. Therefore, it is to be understood that where an action is shown or described as being performed by a user, in various implementations and/or circumstances the action may be performed entirely by the user's computing device or by the user, using their computing device to a greater or lesser extent (e.g. a user may type out a response or input an action, or may choose from preselected responses or actions generated by the computing device). Similarly, where an action is shown or described as being carried out by a computing device, the action may be performed autonomously by that computing device or with more or less user input, in various circumstances and implementations.

In this disclosure, various implementations of a computer system architecture are possible, including, for instance, thin client (computing device for display and data entry) with fat server (cloud for app software, processing, and database), fat client (app software, processing, and display) with thin server (database), edge-fog-cloud computing, and other possible architectural implementations known in the art.

Generally, embodiments of the present disclosure relate to alphanumeric codes and their use on displays. The code may be used to convey information to an individual viewing the display. The information may be, for example, advertising or marketing information related to a good (e.g., a product, real estate, and the like) and/or a service (e.g., a gym membership).

As used herein, the term “alphanumeric code” may be a string of letters and/or numbers in sequence. In one example, the alphanumeric code can be a string of between four to six characters that enables a viewer of the code to remember it easily. In another example, the code can be a string of four characters having alternating letters and numerical digits (e.g., letter-numerical digit-letter-numerical digit). Non-limiting examples include, for instance, A1B3, H7F2, and the like.

As used herein, the term “display” may be any arrangement or presentation of information (e.g., text, pictures, video, and/or any other type of media) shown for one or more individuals to view. Such displays include, for instance, billboards and other types of signs (e.g., signs used for selling or leasing real estate).

The information shown in or on the display may be any kind of information that may be useful or desirable to a viewer, including, for example, information about a good and/or service being advertised. Thus, the information may include, for instance, the specific type of good and/or service, where the good and/or service is sold, contact information for a salesman or other representative of a company or organization that is selling or marketing the good and/or service, and the like.

In at least one example, a non-transitory computer-readable storage medium is disclosed, having instructions stored thereon that, when executed by a computing device, cause the computing device to perform operations, the operations including transmitting a graphical user interface (GUI) configured to permit a user to (i) enter information relating to a parcel of real property, and (ii) initiate a search of a database to find a property of interest, receiving the information relating to the parcel of real property: generating a first alphanumeric code, associating the alphanumeric code with the parcel of real property, and storing the alphanumeric code and the information in the database, receiving the user-initiated search of the database: receiving a second alphanumeric code associated with the property of interest, searching the database for the second alphanumeric code, retrieving property information related to the property of interest, and transmitting the property information to the user.

The first alphanumeric code and the second alphanumeric code can each include at least four characters. Additionally, both (i) a first character in the at least four characters and (ii) a third character in the at least four characters can be alphabetical letters. Further, both (i) a second character in the at least four characters and (ii) a fourth character in the at least four characters are numerical digits.

In another example, the aforementioned information relating to a parcel of real property includes at least one of a property description and an address.

In at least one example, a non-transitory computer-readable storage medium is disclosed, having instructions stored thereon that, when executed by a computing device, cause the computing device to perform operations, the operations including transmitting a GUI configured to permit a user to enter (i) property information relating to a parcel of real property, (ii) personal information relating to the user, and (iii) the user's billing information, receiving the property information relating to the parcel of real property, the personal information, and the user's billing information, generating an account for the user, the account including the property information, the personal information, and the billing information, generating an alphanumeric code, associating the alphanumeric code with the parcel of real property, and storing the alphanumeric code and the property information in a database.

The aforementioned alphanumeric code can have four characters. Additionally, both (i) the first character in the four characters and (ii) the third character in the four characters are alphabetical letters. Further, both (i) the second character in the four characters and (ii) the fourth character in the four characters are numerical digits.

In another example, the aforementioned property information includes at least one of a property description, an address, and media associated with the parcel of real property. Further, the parcel of real property may be under construction.

In another example, the media includes at least one of one or more photographs and one or more videos.

In at least one example, a non-transitory computer-readable storage medium is disclosed, having instructions stored thereon that, when executed by a computing device, cause the computing device to perform operations, the operations including transmitting a GUI configured to permit a user to search a database, the database including a plurality of alphanumeric codes and information on a plurality of parcels of real property, wherein each of the plurality of alphanumeric codes is uniquely associated with one of the plurality of parcels of real property, receiving a first alphanumeric code entered by the user, retrieving the first alphanumeric code in the plurality of alphanumeric codes, retrieving a first parcel of real property in the plurality of parcels that is associated with the first alphanumeric code, and transmitting, by the GUI, information on the first parcel of real property.

Each alphanumeric code in the plurality of alphanumeric codes can have four characters. Additionally, both (i) the first character in the four characters and (ii) the third character in the four characters are alphabetical letters. Further, both (i) the second character in the four characters and (ii) the fourth character in the four characters are numerical digits.

In another example, the information on the first parcel of real property includes at least one of a property description, an address, and media associated with the parcel of real property. The media can include at least one of one or more photographs and one or more videos. Further, the first parcel of real property may be under construction.

In at least one example, a method for displaying and retrieving information is disclosed. The method includes displaying a visual display that includes (i) an alphanumeric code having a first through a fourth character, the first and the third characters being alphabetical letters, and the second and the fourth characters being numerical digits, and (ii) one or more products or services associated with the alphanumeric code, generating, by at least one processor, a GUI that prompts a user to enter the alphanumeric code, transmitting, by the at least one processor, the GUI to the user, receiving, by the at least one processor, the alphanumeric code, retrieving, by the at least one processor, information from a database relating to the one or more products or services associated with the alphanumeric code, and transmitting, by the at least one processor, the information to the user.

In another example, the aforementioned one or more products or services includes a parcel of real property.

In another example, the information includes at least one of a description of the parcel of real property, an address of the parcel of real property, one or more photographs of the parcel of real property, and one or more videos of the parcel of real property. Further, the parcel of real property may be under construction.

In another example, the visual display does not have a quick response (QR) code.

In another example, the method further includes prompting, by the at least one processor, an individual to enter the information relating to the one or more products or services into the database, and generating, by the at least one processor, the alphanumeric code.

In another example, the method further includes generating a plurality of tables, the tables including a property types table, a property table, a customer table, a security questions table, and an invoice table.

The property table can include data on types of real property in which the user is interested. Further, the property table can include the information and the alphanumeric code.

The customer table can include data relating to the user, the data comprising at least one of the user's name, the user's residential address, the user's telephone number, and the user's e-mail address.

The security questions table can include one or more security questions provided by the user and one or more answers to the one or more security questions.

The invoice table can include billing data, and the billing data can include at least one of the user's credit card number, the user's billing address, one or more billing amounts, and one or more dates corresponding to the one or more billing amounts.

In at least one example, the alphanumeric code conveys information to a viewer of the code as follows. The viewer can view and remember the code, which is easier to remember than if the display had shown the entirety of the information. The viewer can then enter the code into a user interface element such as a textbox or form on a web site or a user interface element associated with a mobile application, resulting in the generation and/or display of the information on an electronic device (e.g., computer, laptop, smartphone, tablet, or other personal device).

As a non-limiting example, signs used for the selling or leasing of real estate (referred to herein as “real estate signs”) typically include one or more of the following pieces of information: (1) the type of real property (e.g., commercial real estate, residential real estate, office space), (2) the address or location of the property, (3) a description of the property (e.g., the property's square footage, whether the property was recently renovated, and the like), (4) whether the property is for sale or for lease, (5) how a viewer of the sign can view the property (e.g., times and dates of an open house), (6) the name of the real estate agent and/or real estate company offering the property for sale or lease, and (7) contact information for the real estate agent and/or real estate company (e.g., telephone, e-mail, website, and the like). Instead of displaying one or more pieces of the aforementioned information, a real estate sign may display only an alphanumeric code as described herein. A viewer of the sign that is interested in the property may then go to a website or mobile application (e.g., one that is operated by the real estate company or brokerage firm responsible for selling or leasing the property) and provide the code using an input device. After entry of the code, the website or mobile application may send a request to at least one server computing device, receive a response to the request, and display the aforementioned one or more pieces of information, thereby allowing the viewer to review it at his or her leisure.

It should be appreciated that the alphanumeric codes described herein are especially useful for displays in which one or more individuals will view the display only transiently or for a short period of time. Non-limiting examples of such displays include billboards or signs, including real estate signs, posted alongside roads.

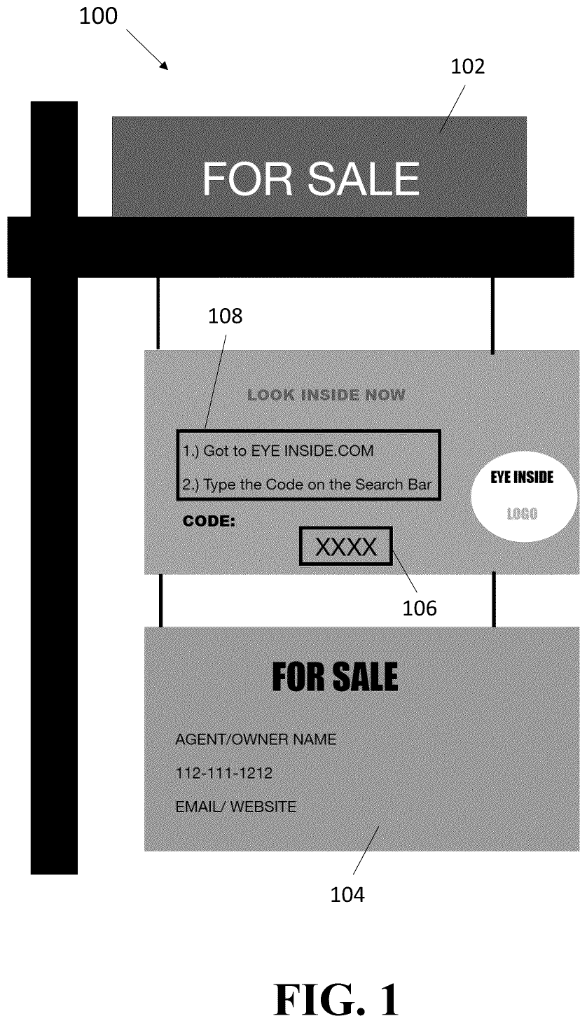

Turning now to FIG. 1, a non-limiting example of a real estate sign 100 is shown. The sign 100 comprises sign portions 102 and 104 that show a viewer of the sign that a specific parcel of property is for sale, as well as the name and contact information of the person responsible for selling the property (e.g., the owner, real estate agent, or the like). The sign 100 further comprises an alphanumeric code 106, which may be any of the alphanumeric codes described herein. For instance, the code 106 may be a four character string of alternating letters and numerical digits in a letter-numerical digit-letter-numerical digit format, such as, for example, H4S7. The sign 100 further comprises a sign portion 108 that instructs a viewer of the sign to enter the code 106 into user interface element such as a textbox or form in order to obtain additional information on the property for sale. A website or mobile application may contain a search bar, search field, or other field that enables the viewer to type or enter the code 106 into the user interface element. After entry of the code, the client computing device may send a representation of the code in a request to a server computing device. The server computing device may receive the request and send a response to the client computing device. As a result, the client computing device may display the aforementioned additional information for the viewer.

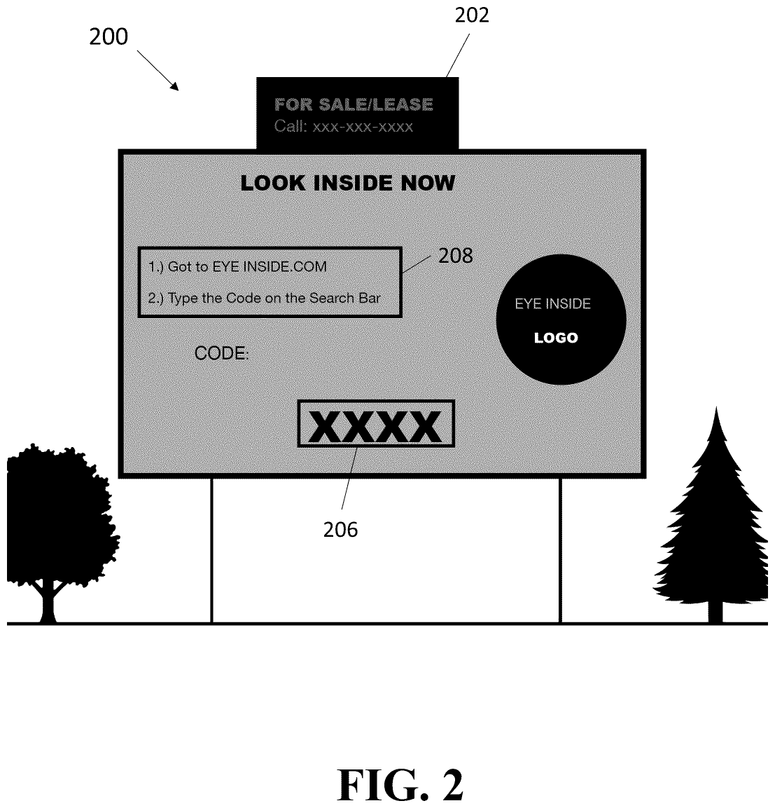

A further non-limiting example of a real estate sign that includes an alphanumeric code is shown in FIG. 2. As in FIG. 1, the real estate sign 200 comprises a sign portion 202 that displays or indicates that a specific parcel of property is for sale or for lease, as well as contact information (e.g., a telephone number) for the individual responsible for selling or leasing the property. The sign 200 further comprises an alphanumeric code 206, which may be any of the alphanumeric codes described herein, including, for example, the alphanumeric code 106. The sign 200 additionally comprises a sign portion 208 that instructs a viewer of the sign to enter the code 206 into a website or mobile application in order to obtain additional information on the property for sale or for lease. As in FIG. 1, the website may contain a user interface element such as a search bar, search field, or other field that enables the viewer to type or enter the code 206 into the website. After entry of the code, the client computing device may send a representation of the code in a request to a server computing device. The server computing device may receive the request and send a response to the client computing device. As a result, the client computing device may display the aforementioned additional information for the viewer.

A skilled artisan will appreciate that the alphanumeric codes described herein may be shown on displays for any variety of products and/or services, and are not solely limited to real estate signs or the selling or leasing of existing parcels of real property. A display may use one or more alphanumeric codes to advertise or market, for instance, real property (e.g., an apartment or office building) that has not yet been constructed, a private school, consumer products, gym memberships, and the like. For instance, a display that advertises apartment buildings that have not yet been constructed or finished may include an alphanumeric code that, when entered into a website or mobile application, will provide an individual with information (e.g., pictures or video) on what specific apartments will look like when completed. Similarly, a display that advertises a gym may include an alphanumeric code that, when entered into a website or mobile application, will provide an individual with information on gym memberships, pricing for such memberships, what services or benefits a membership includes, fitness classes offered by the gym, and the like.

As mentioned herein with respect to FIGS. 1 and 2, a display that includes an alphanumeric code may be associated with a user interface displayed as part of a website. This website may be owned and/or operated by an individual or company responsible for advertising or marketing the good and/or service. When a viewer of the display accesses the website, the viewer can enter the alphanumeric code to retrieve additional information about the good and/or service advertised or marketed on the display. Such additional information can be provided by the individual or company responsible for advertising or marketing the good and/or service. In the non-limiting example of selling or leasing real estate, the additional information could include, for instance, pictures of the property or property specifications (e.g., square footage measurements, number of bedrooms and bathrooms, and the like) that are provided and/or uploaded by the seller or lessor of the property.

In at least one embodiment, the website may keep track of information about the viewer or prompt the viewer to enter personal information (e.g., name and contact information) into the website. Thus, the individual or company responsible for advertising or marketing the good and/or service shown on the display (e.g., a seller or lessor of real property) would be able to know that the viewer has already seen the information provided by the website.

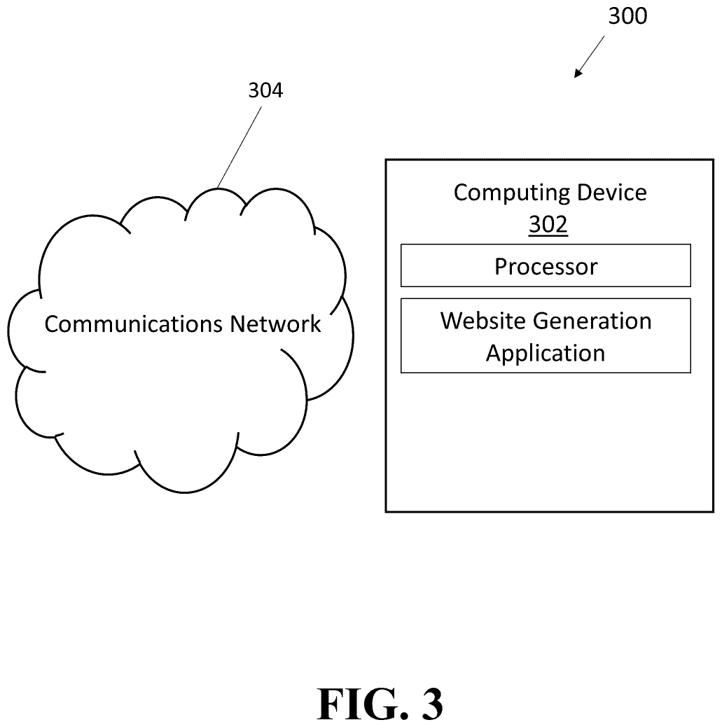

Turning now to FIG. 3, a block diagram is shown of a computing system 300 for controlling and operating a website or mobile application as mentioned above herein, according to an example embodiment. Thus, the computing system 300 may control, for instance, a website or mobile application that prompts a viewer of a display (e.g., sign 100 or sign 200) containing an alphanumeric code (e.g., code 106 or code 206) to enter that code into a user interface element.

The system 300 comprises one or more computing devices 302 that may execute one or more applications to provide a website (e.g., a website application), search for information related to a given alphanumeric code entered by a viewer (e.g., a search application), and transmit the retrieved information to a client computing device for display on the client computing device.

The one or more computing devices 302 can also be used to store a plurality of alphanumeric codes, as well as individual items of information associated with the plurality of codes, in memory and/or a database. The memory may be communicatively coupled to one or more hardware processing devices.

The one or more computing devices 302 may further be connected to a communications network 304, which can be the Internet, an intranet, or another wired or wireless communication network. For example, the communication network 304 may include a Mobile Communications (GSM) network, a code division multiple access (CDMA) network, 3rd Generation Partnership Project (GPP) network, an Internet Protocol (IP) network, a wireless application protocol (WAP) network, a Wi-Fi network, a satellite communications network, or an IEEE 802.11 standards network, as well as various communications thereof. Other conventional and/or later developed wired and wireless networks may also be used.

The one or more computing devices 302 include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or component of the object imaging and detection application. In addition, the one or more computing devices 302 further include at least one communications interface to transmit and receive communications, messages, and/or signals.

Thus, information processed by the one or more computing devices 302, or the applications executed thereon, may be sent to another computing device for display on a browser or application of the other computing device, such as a remote computing device, via the communication network 304.

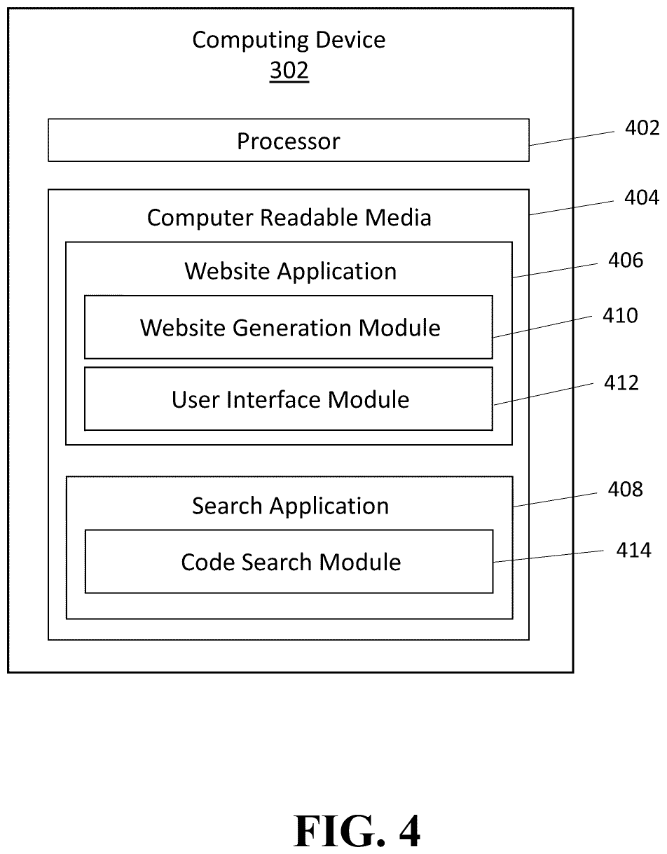

FIG. 4 illustrates a block diagram of a computing device 302 according to an example embodiment. The computing device 302 includes computer readable media (CRM) 404 in memory on which a website application 406, a search application 408, and other applications or modules are stored. The computer readable media may include volatile media, nonvolatile media, removable media, non-removable media, and/or another available medium that can be accessed by the processor 402. By way of example and not limitation, the computer readable media comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

The aforementioned website application 406 includes a website generation module 410 that is operable to generate a website for display using the user interface module 412. As mentioned above herein, the website comprises a user interface element (e.g., text bar, search bar, search field, form, etc.) that enables entry of one or more alphanumeric codes). The aforementioned search application 408 includes a code search module 414 that searches memory and/or a database for information associated with the entered one or more alphanumeric codes.

Using a local high-speed network, the computing device 302 may, in near real time, receive any data request (e.g., the one or more alphanumeric codes) from a client computing device, process the data request, and send a response to the client computing device. This response may result in the client computing device displaying additional information associated with the entered one or more alphanumeric codes for the viewer.

The data and/or data requests may be monitored to generate an event and an alert if something is out of range or incorrect (e.g., an entered alphanumeric code is of the wrong format, is not found in the memory and/or database, etc.). Such alerts may be sent in real-time or near real-time using an existing uplink or dedicated link. The alerts may be sent using email, SMS, push notification, or using an online messaging platform to end users and computing devices.

The website application 406 may, via user interface module 412, display a user interface on a display device. As an example, the user interface module 412 generates a native and/or web-based graphical user interface (GUI) that accepts input and provides output viewed by users of a client computing device. The computing device 302 may receive a data request (e.g., one or more alphanumeric codes) from the client computing device, process the data request (e.g., by using the code search module 414 of the search application 408 to search memory and/or a database for additional information associated with the entered one or more alphanumeric codes), and send a response to the data request (e.g., the additional information found) to the client computing device for display thereon. The receipt of the data request, processing of the data request, and sending of the response may be performed asynchronously without interfering with the display and behavior of the user interface displayed by the client computing device.

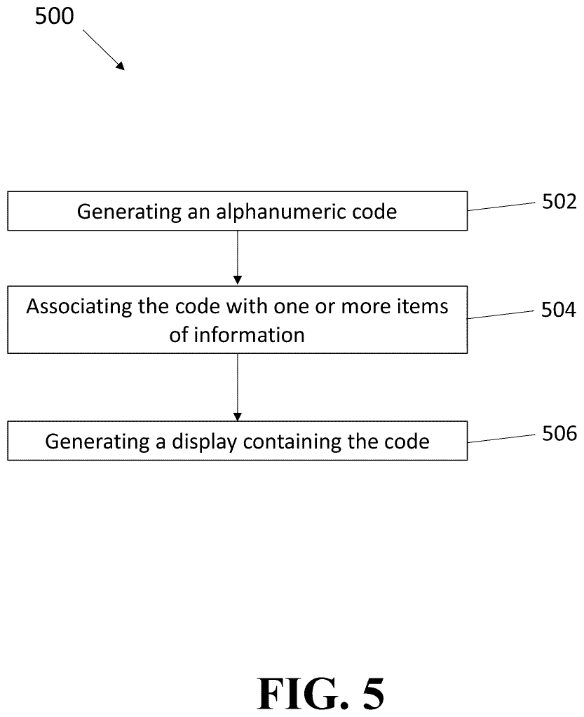

In at least a further embodiment, a method is disclosed for generating one or more alphanumeric codes. The method may use the alphanumeric codes, displays, and websites or mobile applications mentioned above herein. Thus, turning to FIG. 5, a method 500 comprises, at block 502, generating an alphanumeric code, which may be any alphanumeric code described herein. At block 504, the alphanumeric code is associated with, or assigned to, one or more items of information. Such information can be provided by any individual that wishes to market, sell, and/or advertise a good and/or service. As a non-limiting example, the information could be pictures or videos of a parcel of real property that the individual (e.g., the owner of the property or a real estate agent) wishes to sell. The information could further include the individual's contact information (e.g., name, telephone number, e-mail address, etc.). In at least one embodiment, the individual uploads the information using a website, such as, for instance, any website described above herein.

At block 506, a display, which may be any of the displays mentioned above herein, is generated that includes the alphanumeric code generated at block 502 and associated with one or more items of information at block 504. The display can then be sent to the individual or placed in a location for viewing. It should be appreciated that this display may, in at least one example, include only the alphanumeric code and can be added to one or more other signs or displays.

Any viewer of the display with the alphanumeric code may then enter the code via a user interface element, e.g., on a website or mobile application as described above herein, to obtain the information that has already been associated with that code at block 504. Entering the code and retrieving the information may proceed as described herein in FIGS. 3-4.

As disclosed above herein, one or more computing devices and/or computing systems may be used for controlling and operating a website or mobile application that prompts a viewer of a display (e.g., sign 100 or sign 200) containing an alphanumeric code (e.g., code 106 or code 206) to enter that code into a user interface element. In at least one example of the disclosure, a website and/or mobile application includes both a front-end and back-end implementation. The front-end implementation has at least the following components: a client-side system process and its associated program methods (e.g., client registration, billing, a customer data structure, and a customer interface). The back-end implementation has at least a server-side system process and its associated components (e.g., a database such as, for instance, a Structured Query Language (SQL) database, and a platform application that may be based on the Node.js runtime environment), based on an example entity relationship model shown herein. The front-end and back-end implementations are connected by a framework (e.g., the Express.js framework). Both the front-end and back-end implementations may be housed together in cloud computing infrastructure and/or cloud computing platforms.

By accessing a website via, e.g., an Internet portal, a user can interact with specific components such as (1) a search interface to search for one or more alphanumeric codes as described herein (e.g., code 106 or code 206), and (2) a client profile that contains user data (e.g., the user's phone number, e-mail address, and/or other personal information, the real estate listings and/or properties for which the user is interested, and the like). These components may further allow a user to search for real estate listings on the Internet, and register to list a property through the website, among others.

It should be appreciated that the terms “user,” “customer,” and “client” are used interchangeably herein. Such terms refer to an individual that is accessing the website and/or mobile application and, in at least one embodiment of the disclosure, registering with that website and/or mobile application by providing personal information and/or information on one or more real estate properties in which he or she is interested.

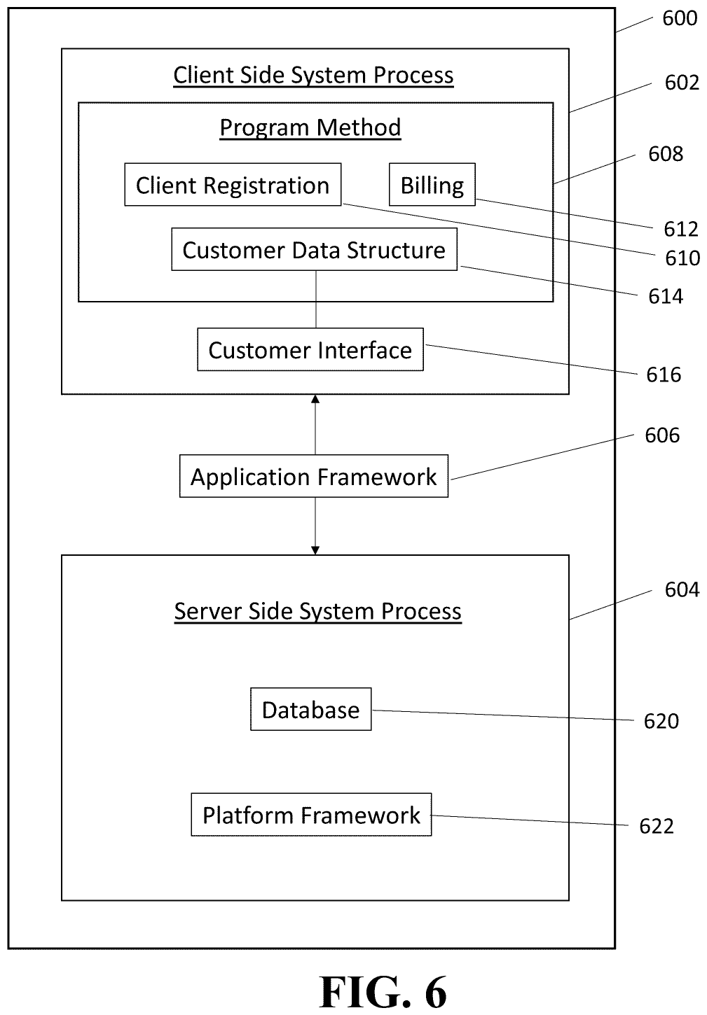

Turning now to FIG. 6, a system architecture 600 of a website and/or mobile application is shown. The system architecture 600 comprises a client-side system process 602, a server-side system process 604, and an application framework 606 connecting the client-side system process and the server-side system process.

The client-side system process 602 uses a program method 608 with multiple components and/or modules. A client registration component 610 enables new users of the website and/or mobile application to register their personal information (e.g., name, address, phone number, e-mail address, etc.) and any information regarding one or more real estate properties of interest (e.g., properties that the user would like to list for sale). A billing component 612 acquires the user's billing information and processes payments through a banking or other payment portal. A customer data structure 614 encapsulates user data acquired during registration (e.g., via the client registration component 610) and translates the data into an object notation form to submit to a server. Finally, a customer interface 616 allows users to, e.g., update their registered information, deactivate their account, manage their account, and the like.

The application framework 606, which may be, for instance, the Express.js framework, interacts between the client-side system process 602 and the server-side system process 604. Accordingly, the application framework 606 can store and retrieve data (e.g., user data), produces information (e.g., from user search results), etc.

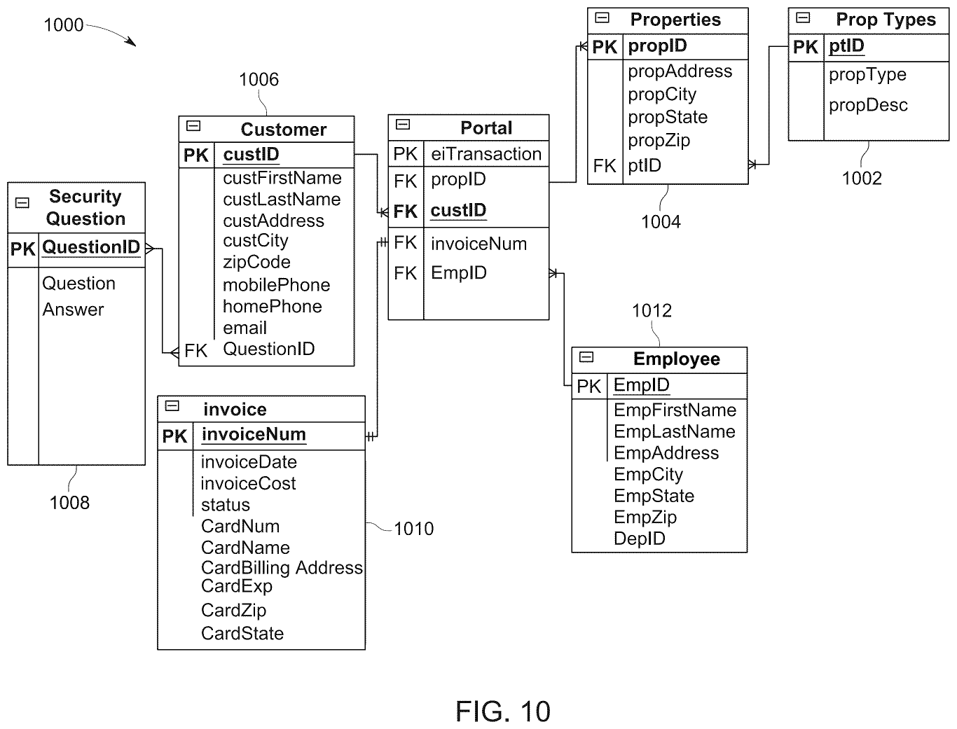

The server-side system process 604 may house a database implementation of the website and/or mobile application's infrastructure. In at least one embodiment, the server-side system process may utilize a SQL database 620 and a platform application 622 (e.g., the Node.js runtime environment). The SQL database 620 is a relational database that can store all data acquired from users, as well as push information to the user side through, e.g., platform application 622 and the application framework 606. This platform application 622 interacts with a server, and the application framework 606 takes information from the platform application and transmits all connections, requests, and methods to the user's Internet browser. The database 620 and the platform framework 622 may be included in an entity relationship model, as described further detail in FIG. 10.

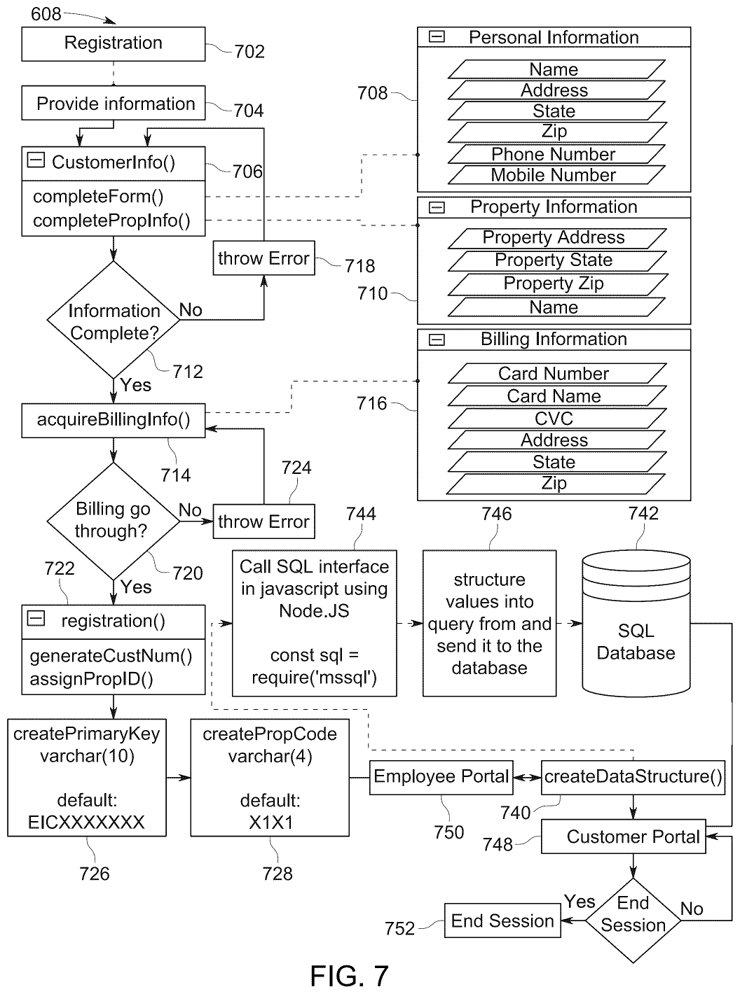

The program method 608 is illustrated in further detail in FIG. 7. At block 702, a user registers with the mobile application and/or website and provides user information (e.g., name, address, phone number, e-mail address, etc.) at block 704. At block 706, customerInfo( ) is a class that includes two functions: (1) the completeForm( ) function, and (2) the completePropInfo( ) function. The completeForm( ) function can acquire user information 708, which can be, for instance, the user's name, address, state of residence, ZIP code, phone number, and mobile number. The completePropInfo( ) function can acquire additional information 710 about a property of interest (e.g., a property that the user wishes to list for sale on the website). This information 710 can include, for instance, the property's address, the state in which the property is located, the ZIP code in which the property is located, and the name of the property. At block 712, the method determines if the information 708 and 710 provided is complete. If so, the method moves to block 714, in which the acquireBillingInfo( ) function can acquire billing information 716 from the user. Such information 716 may include, for instance, a credit card number, a credit card name, a card verification code (CVC) number, and the user's billing address (including state and ZIP code). The information 716 is then provided to a bank and/or payment portal. If the information 708 and 710 is not complete, the method instead moves to block 718, in which an error is generated and displayed to the user.

Once billing information 716 is acquired, the method, at block 720, determines whether payment was processed correctly. If so, the method moves to block 722, in which the registration( ) class can call two specific functions: (1) the generateCustNum( ) function, and (2) the assignPropID function. The generateCustNum( ) function can generate a user identification (ID) number, while the assignPropID function may generate a unique code for the property to be listed and sold. This code may be, for instance, an alphanumeric code as described above herein (e.g., code 106 or 206). If payment was not processed correctly, the method instead moves to block 724. An error may be generated and displayed to the user.

The unique code for each given property may be generated by first generating, at block 726, a key string of, e.g., ten characters. Then, at block 728, an alphanumeric code of, e.g., four characters is generated. The key string is a value that can be used to uniquely reference and/or identify the alphanumeric code and/or other information (e.g., property information) stored in the database.

At block 740, the createDataStructure( ) function can generate a data structure that includes data (e.g., the unique code for the property, user information 708, additional information 710, and/or billing information 716) to be submitted as scripts (e.g., SQL scripts) to the database 742 (e.g., an SQL database). This may be done by, for instance, calling an SQL interface using Node.js, which is shown at block 744. Then, at block 746, structure values are sent to the database 742. In at least one example, the database may be stored in the cloud to minimize downtime. However, it should be appreciated that information stored in the database may be backed up in one or more other databases for redundancy and to ensure continuity.

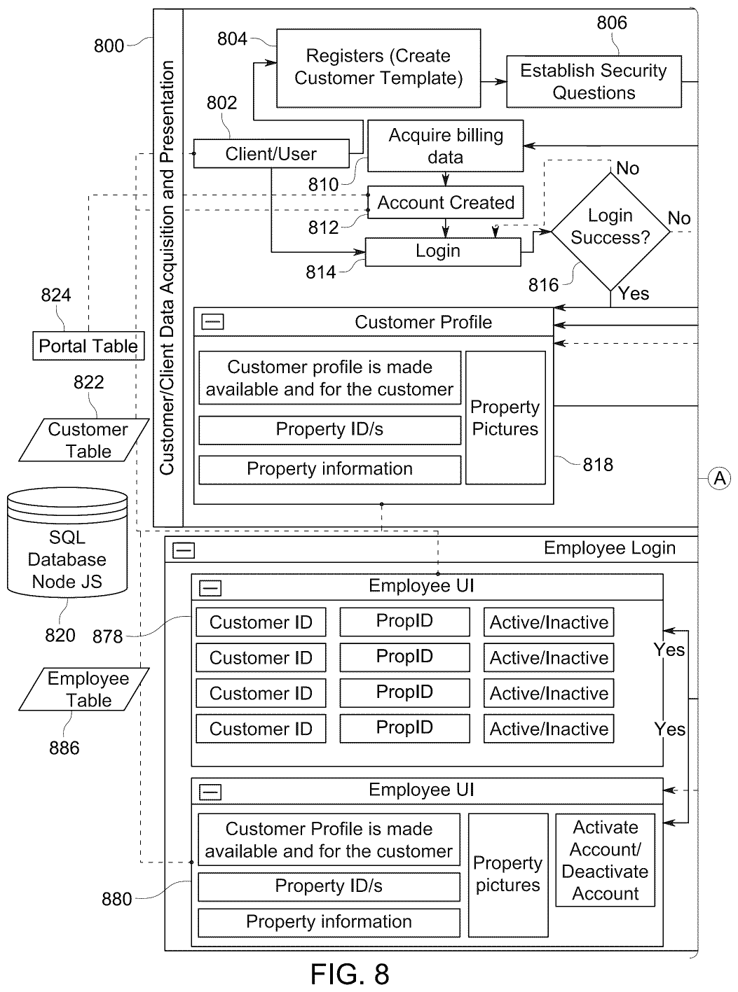

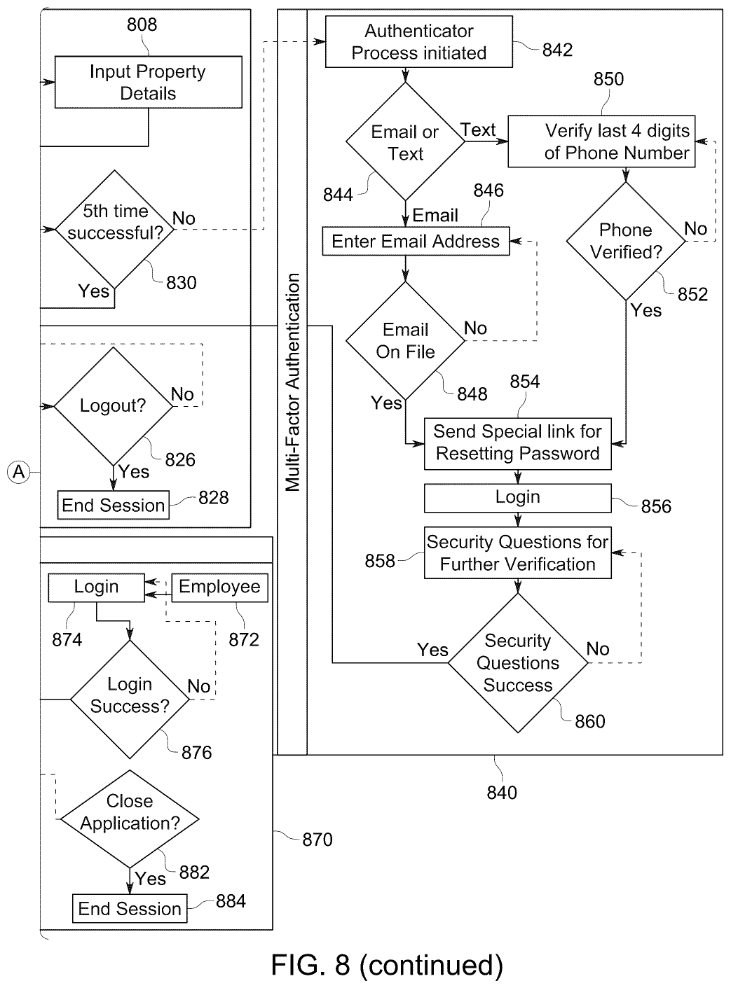

The createDataStructure( ) function is connected to both a customer portal 748 and an employee portal 750. The customer portal 748 enables a user to access the website and/or mobile application, and is described in further detail in FIG. 8. As shown at block 752, a user may also use the portal 744 to end a session and/or log out from the website and/or mobile application. The employee portal 750 can allow one or more employees responsible for maintaining and/or managing the website and/or mobile application to access the website and/or mobile application. Such employee portal is also shown in further detail in FIG. 8 and described herein.

The following is a non-limiting example of pseudocode that may be used to generate, e.g., at block 728, any of the alphanumeric codes described herein (e.g., code 106 or 206).

```
  function assignPropID(val) { //can only use return if there's a value
within the parameters to be returned. if not, then console.log
  let numbers = “1234567890”; // numbers
  let alphabets = “abcdefghijklmnopqrstuvwxyz” //alphabet
  val = “” // val needs to be initialized for it not to return NaN
    for (let x = 0; x < 4; x++) {
        if(x===1 ∥ x===3){
        val += numbers.charAt(Math.floor(Math.random( ) *
      numbers.length));
        } else {
        val += alphabets.charAt(Math.floor(Math.random( ) *
      alphabets.length));
        }
        }
  // add a function that goes through the database and assess if val is an
  existing code
    //the value of val must not be duplicated in the database
    return val.toUpperCase( ); //make lower case letters to uppercase
    }
```

In the above pseudocode, the function “Math.random( )” is a function that generates a random value greater than or equal to zero, but less than one. Thus, “Math.random( )*numbers.length” defines a maximum number of the length of the string ‘numbers.’ In the above pseudocode, the string ‘numbers’ has a length of 10. The function “Math.floor( )” is a function that always rounds down and returns the largest integer less than or equal to a given number. The function “.charAt( )” is a function that requires an integer, such as, for instance, “.charAt(0),” where ‘number( )’ is an index reference of the value of the string. Accordingly, “.charAt( )” is a function for strings to select the character in a certain index of a string. For example, “numbers.charAt(3)” will return the character “4” from the ‘numbers’ string since the iteration starts at an index value of “0.”

Turning now to FIG. 8, various processes within the website and/or mobile application are presented. These processes include: (1) a customer data process 800, (2) a multi-factor authentication process 840, and (3) an employee login process 870.

In the customer data process 800, a user 802 first registers with the website and/or mobile application at block 804. At block 806, the website and/or mobile application prompts the user to establish security questions that verify and/or confirm the user's identity. At block 808, the website and/or mobile application prompts the user to input details of one or more real estate properties in which the user is interested (e.g., one or more properties the user wishes to sell or lease). Then, at block 810, the website and/or mobile application collects billing and/or payment from the user. The user's account is then created at block 812, enabling the user to login, which is shown at block 814.

When a user logs in to the website and/or mobile application after having created an account therein, a successful log-in, shown at block 816, leads the user to a customer profile interface 818. It should be appreciated that such an interface may only be one portion of the user's account. The profile interface 818 may show various information specific to the user, such as, for instance, identifiers of one or more real estate properties in which the user is interested (e.g., one or more properties the user wishes to sell or lease), pictures of the aforementioned properties, and details regarding the aforementioned properties (e.g., size, location, etc.). In at least one example, the aforementioned identifiers may be one or more alphanumeric codes as described above herein (e.g., code 106 or code 206).

After the user is finished using the website and/or mobile application, the user may logout of the website and/or mobile application at block 826, leading to the end of the log-in session, which is shown at block 828.

Various items of user data, such as, for instance, the information collected by the website and/or mobile application upon new user registration, can be stored in a customer table 822. Billing data, such as, for instance, the user's credit card and/or payment information, can be stored separately within a portal table 824. The customer table 822 and/or the portal table 824 are located within a database 820 (e.g., a SQL database).

It should further be appreciated that a user may attempt to log-in to the website and/or mobile application, but fail to do so. After a pre-set number of unsuccessful log-in attempts, shown at block 830, the multi-factor authentication process 840 can be activated. This pre-set number may be, for instance, five unsuccessful attempts. It may also be three, four, or more than five unsuccessful attempts.

The multi-factor authentication process 840 is initiated at block 842 (e.g., when a given user unsuccessfully attempts to access the website and/or mobile application a pre-set number of times). At block 844, the website and/or mobile application prompts and/or notifies the user with either an e-mail or a text/SMS message.

If an email notification is sent, the user is prompted to enter his or her email address, shown at block 846. The website and/or mobile application then determines, at block 848, whether the user has an email already registered and/or on file. If so, at block 854, the website and/or mobile application may automatically provide the user with one or more methods to reset his or her password. Such methods may be, for instance, a web site link sent to the user's e-mail account.

If a text/SMS message is sent, the user may be prompted, at block 850, to verify his or her identity (e.g., verifying the last four digits of his or her phone number). The website and/or mobile application then verifies, at block 852, the user's phone number. After such verification, at block 854, the website and/or mobile application may automatically provide the user with one or more methods to reset his or her password, as described above herein.

After the user resets his or her password, the user may login to the website and/or mobile application at block 856. The user may be further prompted, at block 858, to answer one or more security questions to verify the user's identity. Such questions may be, for example, drawn from the security questions established at block 806 when the user first registered his or her account. At block 860, the website and/or mobile application determines whether the user has successfully answered the one or more security questions. If so, the user may successfully access the website and be directed to, for instance, the customer profile interface 818.

Lastly, the employee login process 870 is used by one or more employees responsible for operating and/or maintaining the website and/or mobile application. An employee 872 logs in to the website and/or mobile application at block 874. Upon successful log-in, shown at block 876, various employee interfaces may be presented. These include, for instance, employee interfaces 878 and 880. Such interfaces may show different items of information relating to registered users and/or the properties in which they are interested. For example, employee interface 878 displays individual user identifiers, individual property identifiers (e.g., the alphanumeric codes described herein), whether individual users are active and/or current on their billing payments or not, and whether individual properties are active (e.g., unsold) or not. Employee interface 880 can display information related to a specific selected user, including, for example, that user's account and/or profile information, the properties in which the user is interested, the identifiers for such properties (e.g., the alphanumeric codes described herein), and whether the user's account is active or inactive. The interface 880 may further permit an employee to select whether to activate and/or deactivate the user's account. After the employee is finished using the website and/or mobile application, the user employee may exit the website and/or mobile application at block 882, leading to the end of the log-in session, which is shown at block 884.

Information and/or data relating to employees can be stored in employee table 886. This table can be stored in a database that is separate from the database 820.

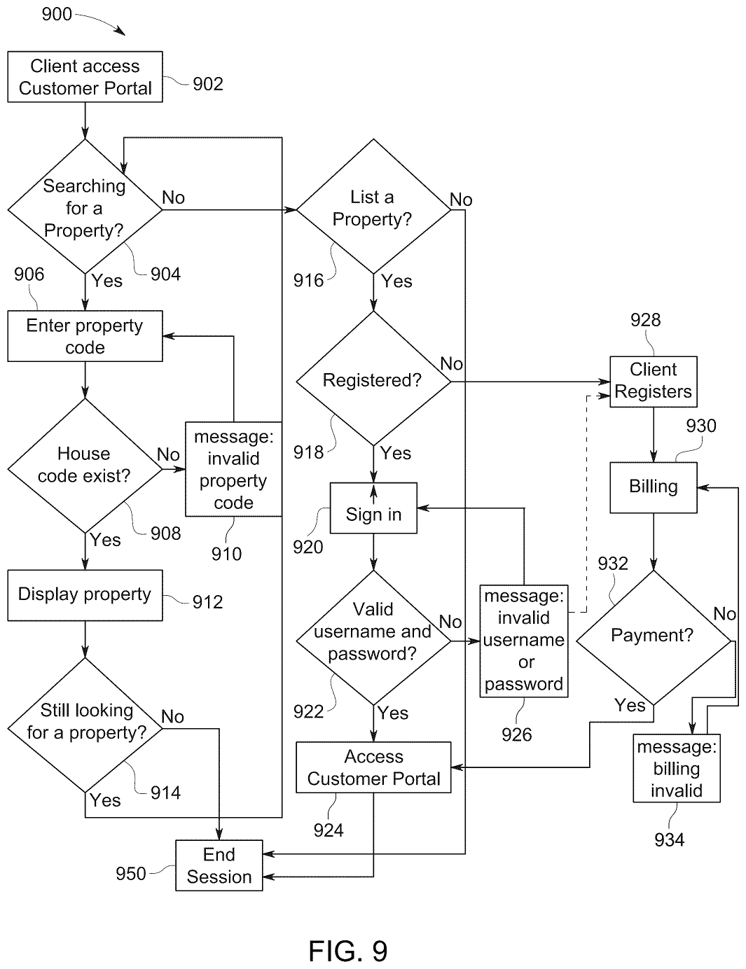

FIG. 9 is a block diagram of a user process 900 when the user accesses the website and/or mobile application. At block 902, the user accesses the customer portal (e.g., customer interface 818) by, for instance, logging into the website and/or mobile application. At block 904, the website and/or mobile application determines if the user is searching for a property of interest (e.g., a property that the user wishes to purchase). If the user is searching for a property, the website and/or mobile application prompts the user for a property code at block 906. This property code may be, for instance, an alphanumeric code as disclosed above herein (e.g., code 106 or code 206). Then, at block 908, the website and/or mobile application determines whether the property code exists. If not, an error is generated and displayed to the user at block 910. If the property code does exist, the website and/or mobile application displays, at block 912, the property associated with the input property code. The website and/or mobile application can also determine, at block 914, whether the user is still searching for another property. If so, the process 900 returns to block 904. If not, the user may end the session at block 950.

If the user is not searching for a property, the website and/or mobile application can prompt the user, at block 916, as to whether or not he or she wishes to list a property for sale and/or rent. If the user wishes to list a property, the website and/or mobile application then determines, at block 918, whether the user is registered and/or has an account. If the user has an account, the website and/or mobile application prompts the user, at block 920, to sign in.

Then, at block 922, the website and/or mobile application determines whether the credentials (e.g., username and/or password) entered by the user are valid. If so, the website and/or mobile application presents the customer portal (e.g., customer interface 818) to the user at block 924. After the user finishes using the website and/or mobile application, he or she can end the session at block 950. If the credentials entered by the user are not valid, an error message is generated and displayed to the user at block 926.

If the user is not registered and/or does not have an account, the website and/or mobile application can prompt the user to register at block 928. Registration may encompass any of the steps described above herein, e.g., with respect to method 800. Thus, at block 930, the website and/or mobile application prompts the user to enter billing and/or payment information. The user can then make a payment at block 932. If billing is successful, the website and/or mobile application displays the customer portal (e.g., customer interface 818) at block 924. If billing is unsuccessful, the website and/or mobile application generates an error message and displays the error message to the user at block 932.

Turning now to FIG. 10, an example entity relationship model 1000 is shown. As described above herein, this entity relationship model is part of a server-side system process (e.g., server-side system process 604). The model 1000 includes various different tables and/or lists, each containing different types of information. Specifically, the model includes: (1) a table 1002 for types of real estate properties (also referred to herein as the “property types table”), (2) a table 1004 for the properties themselves (also referred to herein as the “property table”), (3) a customer table 1006 that stores representations of different items of data relating to the user, (4) a security questions table 1008 that stores representations of security questions and their associated answers, (5) an invoice table 1010 that lists representations of individual transactions of a given user (e.g., individual billing and/or payment items), and (6) an employee table 1012 that houses information relating to employees that manage and/or maintain the website and/or mobile application. One or more of the aforementioned tables may be connected to a portal 1014 that contains information regarding the user, one or more properties in which the user is interested, and/or payment and/or billing transaction information.

The property types table 1002 may include information on the type of property in which the user is interested (e.g., commercial or residential) and a description of a given property in which the user is interested.

The property table 1004 may include representations of further details on a given property, such as, for instance, the street address, the city and state in which the property is located, and the property's ZIP code. The table 1004 may also include the property types table 1002 and/or information contained therein. Thus, it should be appreciated that one or more of the tables in the entity relationship model 1000 may be arranged in a nested formation. Additionally, the table 1004 may list one or more alphanumeric codes as described herein (e.g., code 106 or code 206) that identify a given property of interest.

The customer table 1006 can store representations of data related to the user, which may have been provided by the user upon registration, as described above herein with respect to FIGS. 7-9. Such data includes, for example, the user's first and last names, the user's residential and/or billing address (including street address, city, state, and ZIP code), the user's telephone numbers (e.g., home telephone number, mobile telephone number), and the user's e-mail address. Additionally, the customer table 1006 may have representations of the security questions table 1008 described below, and/or the information contained therein.

The aforementioned security questions table 1008 may include one or more security questions and representations of respective answers. The questions and/or the answers may be provided by the user upon registration, as described above herein with respect to FIG. 8 (e.g., block 806).

The invoice table 1010 stores representations of information relating to individual payment and/or billing transactions. Such information includes, for example, the invoice date, the amount billed, a status of the invoice (e.g., whether or not it has been paid), a credit card number, a name associated with the card, a billing address associated with the card (e.g., street address, city, state, and ZIP code), the card's security code or card verification code (CVC), and the card's expiration date.

The employee table 1012 stores representations of information relating to one or more employees responsible for maintaining and/or managing the website and/or mobile application for the users. Such employee information includes, for example, the employee's first and last names, the employee's residential address (e.g., street address, city, state, and ZIP code), and any information relating to the employee's dependents.

As mentioned above herein, one or more of these tables may be connected to the portal 1014. For instance, the portal may include property table 1004 and/or the information contained therein; the property table 1004 may itself contain the property types table 1002 and/or the information contained therein. Similarly, the security questions table 1008 may be a part of the customer table 1006, since the website and/or mobile application may prompt the user, when registering, to establish security questions, as described in FIG. 8 herein. The portal 1004 may further include the invoice table 1010, the employee table 1012, and/or the information contained therein.

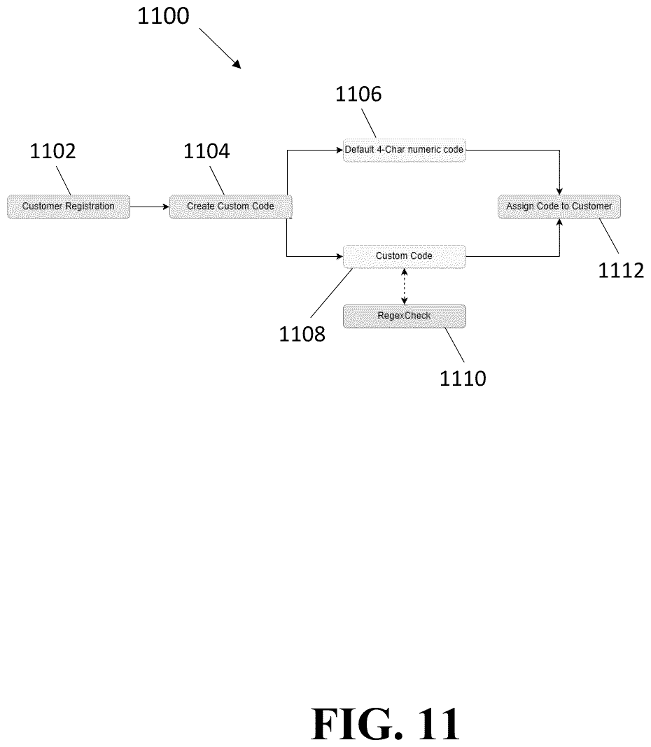

Turning now to FIG. 11, a program method 1100, or portion thereof, is shown. Generally, the method 1100 provides a user with the option to either obtain a randomly generated alphanumeric code (e.g., any one or more alphanumeric codes described herein that can be created by one or more program methods and/or portions thereof described herein, such as block 728) or obtain a code of the user's own choosing. Accordingly, the method 1100 may, in at least one embodiment, be integrated into another program or method such as, for instance, program method 608. At block 1102, a user registers with the mobile application and/or website. Such registration may be similar to, or exactly the same as, other user registration blocks disclosed herein (e.g., block 702).

At block 1104, the user is prompted as to whether the user wishes to create their own custom code. Such a user-created code may be alphanumeric or of a different format. If the user elects to obtain a pre-generated alphanumeric code, the method moves to block 1106. This pre-generated alphanumeric code can be any of the alphanumeric codes described above herein (e.g., code 106, code 206, etc.). By contrast, if the user elects to choose their own custom code, the method moves to block 1108. This custom code can be chosen according to the requirements of a Regular Expression (Regex) Check, which is shown at block 1110. The Regex Check ensures that the user-selected custom code is not previously taken, or active and/or used within a predetermined past portion of time (e.g., one day, one week, one month, or more than one month). The Regex Check can further ensure that the user-created custom code conforms to any one or more formatting requirements (e.g., a requirement that even a user-created custom code is alphanumeric and/or four digits, similar to the pre-generated alphanumeric code from block 1106). In other words, any user-created custom code must pass the Regex Check at block 1110 in order to be used. If the user-created custom code passes the Regex Check, the code will be assigned to the user at block 1112. If the code does not pass the Regex Check, the user will then be prompted to choose another custom code or use a pre-generated code (e.g., the program method may return to block 1104).

The ability for the user to create their own custom code may help the user remember that code. For instance, the user may create a custom code that includes words, letters, and/or numbers of interest and/or personal significance to them, provided that any such code format passes the Regex Check. A user may also create a custom code that includes information relevant to one or more properties to be listed and/or sold (e.g., address abbreviations, street name abbreviations, city abbreviations, location indicators, and the like).

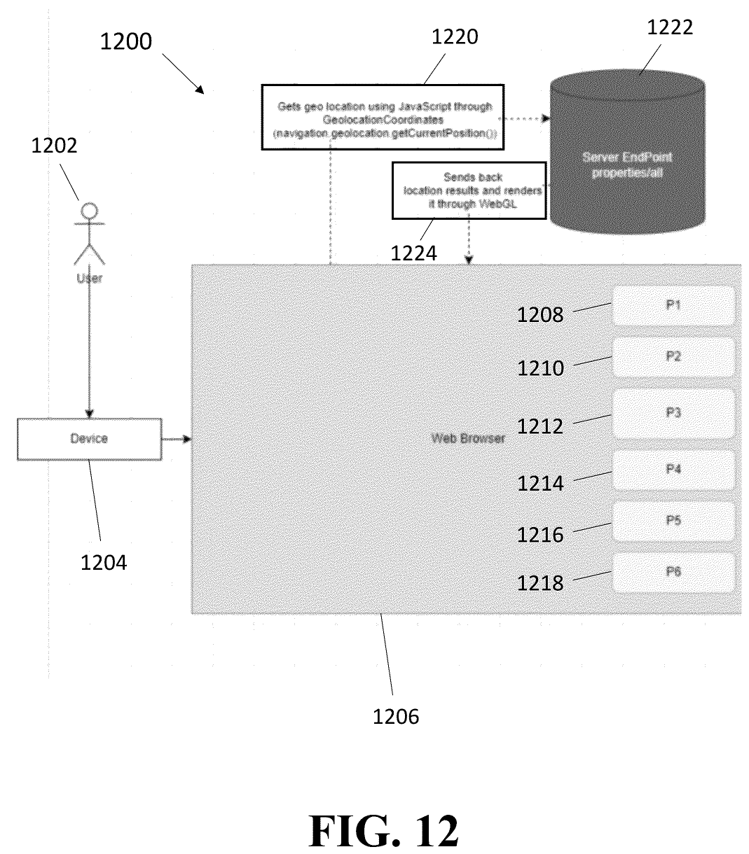

Turning now to FIG. 12, diagram 1200 depicts the usage of location data from a computing device to determine one or more properties that are geographically closest to the user. In one example, a client computing device, e.g., device 1204, may determine a geolocation of the client computing device using at least one of a cellular network, one or more wireless networks, or global positioning system (GPS) hardware to determine latitude and longitude coordinates of the client computing device. The client computing device may determine a geolocation and determine one or more alphanumeric codes associated with the geolocation. Further, the one or more alphanumeric codes may be associated with one or more properties, thereby enabling association between the geolocation, the one or more alphanumeric codes, and the one or more properties. The geolocation can be achieved by, for instance, using ‘navigator.geolocation’ or GeolocationCoordinates as criteria for obtaining properties near the user 1202. A WebGL overlay can be used to create a map instance in the browser application 1206 to reflect different properties 1208, 1210, 1212, 1214, 1216, and 1218 (labeled P1 through P6) that are nearest to a physical and/or geographic location of the device 1204. In this example, the device 1204 provides an improved graphical user interface (GUI) that determines the geolocation of the client computing device and displays one or more properties, and/or one or more associated alphanumeric codes, nearest to the location of the device 1204 on a map graphical user interface using a WebGL overlay by embedding the map to render a graphical representation of the one or more properties and a location of the client computing device in one of two-dimensions and three-dimensions in ways that solves issues associated with graphical memory consumption as opposed to conventional approaches. Additionally, the WebGL overlay provides improved GPU acceleration of image processing by the browser.

Thus, the browser application 1206 can display a website (e.g., any of the websites described above herein) that shows an option for the user 1202 to select properties near the user 1202 (e.g., by entering the one or more codes, or by selecting from a menu of distances from the user, by selecting a radio button associated with distances from the user, or any other similar method). One or more properties near the user can then be displayed with one or more associated alphanumeric codes, as described in further detail below.

In at least one example, the option may be depicted on the browser application as “What's Near Me.” If the user 1202 selects that option, the webpage will open with the WebGL overlay. As shown in block 1220, the website retrieves (e.g., via JavaScript) the desired property information from a server 1222 based on (i) the physical and/or geographic location of the device 1204, and/or (ii) one or more alphanumeric codes associated with the desired property or properties. As shown in block 1224, the geographic coordinates of one or more properties (e.g., one or more of properties 1208, 1210, 1212, 1214, 1216, and 1218) are then obtained from the server 1222. The coordinate information may include, for instance, latitude and/or longitude data. After obtaining the coordinates, WebGL uses the coordinates to render one or more maps to display on the website. Each of these one or more maps contains depictions of (i) the location(s) of one or more properties (e.g., one or more of properties 1208, 1210, 1212, 1214, 1216, and 1218), and/or (ii) the one or more alphanumeric codes associated with these properties. These properties can be displayed on the one or more maps.

The user 1202 can then manipulate one or more aspects of the maps (e.g., via one or more filters) to view the properties. For example, the user can use one or more map filters to restrict the number of properties displayed. Properties displayed can be restricted by, for instance, the distance between the device 1204 and the one or more properties (e.g., a distance of 5 miles, 10 miles, 25 miles, 50 miles, 100 miles, or more than 100 miles). This provides user 1202 with the ability to see nearby properties that are listed on the website, including, for instance, any property for which the user knows an associated code (e.g., any alphanumeric code as described herein).

In one example, the device or client computing device 1204 can determine a particular location of using at least one of a cellular network, one or more wireless networks, and global positioning system (GPS) hardware to determine latitude and longitude coordinates of the client computing device and determine at least one parcel of real property that is under construction that is within a particular distance from the latitude and longitude coordinates of the client computing device. The device 1204 can also display a specific code associated with the parcel of real property (e.g., any alphanumeric code described herein). The device 1204 may display an indicator of the particular location and at least one graphical user interface element that represents each of the at least one parcel of real property on a map using WebGL.

Accordingly, it should be appreciated that the alphanumeric codes described herein can be used on displays such that any viewer of the display that is interested in the good and/or service being marketed or advertised can use the code, by itself, to access further information about the good and/or service. Such a viewer need not know or remember any item of information other than the alphanumeric code. Thus, in the non-limiting example of selling or leasing real estate, a viewer that is interested in buying or leasing the real property being advertised need only remember the alphanumeric code. The viewer need not remember any other information, such as, for example, the address of the property.

It should further be appreciated that the alphanumeric codes described herein have advantages over quick response (QR) codes and other similar technology used to provide additional information to viewers of displays. QR codes require a smartphone or other personal electronic device to capture the QR code in order to obtain the additional information. The viewer cannot remember the QR code. Thus, if the viewer does not have ready access to a smartphone or other electronic device (e.g., if the viewer is driving past the display), the QR code is of no use and the viewer would not be able to access the additional information.

These and other objectives and features of the invention are apparent in the disclosure, which includes the above and ongoing written specification.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

The invention is not limited to the particular embodiments illustrated in the drawings and described above in detail. Those skilled in the art will recognize that other arrangements could be devised. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific illustrative embodiments, modifications and variations of the invention may be constructed without departing from the spirit and scope of the invention as set forth in the following claims.

I/We claim:

1. A non-transitory computer-readable storage medium, having instructions stored thereon that, when executed by a computing device, cause the computing device to perform operations, the operations comprising:
transmitting a graphical user interface (GUI) configured to permit a user to
enter information relating to a parcel of real property, and
initiate a search of a database to find a property of interest;
receiving the information relating to the parcel of real property:
generating a first alphanumeric code,
associating the alphanumeric code with the parcel of real property, and
storing the alphanumeric code and the information in the database;
receiving the user-initiated search of the database:
receiving a second alphanumeric code associated with the property of interest,
searching the database for the second alphanumeric code,
retrieving property information related to the property of interest; and
transmitting the property information to the user,
wherein the first alphanumeric code and the second alphanumeric code each comprises at least four characters,
wherein both (i) a first character in the at least four characters and (ii) a third character in the at least four characters are alphabetical letters, and
wherein both (i) a second character in the at least four characters and (ii) a fourth character in the at least four characters are numerical digits.

2. The non-transitory computer-readable storage medium of claim 1, wherein the information comprises at least one of a property description and an address.

3. A non-transitory computer-readable storage medium, having instructions stored thereon that, when executed by a computing device, cause the computing device to perform operations, the operations comprising:
transmitting a graphical user interface (GUI) configured to permit a user to enter:
property information relating to a parcel of real property,
personal information relating to the user, and
the user's billing information,
receiving the property information relating to the parcel of real property, the personal information, and the user's billing information;
generating an account for the user, the account comprising the property information, the personal information, and the billing information;
generating an alphanumeric code;
associating the alphanumeric code with the parcel of real property; and
storing the alphanumeric code and the property information in a database,
wherein the alphanumeric code has four characters,
wherein both (i) the first character in the four characters and (ii) the third character in the four characters are alphabetical letters, and
wherein both (i) the second character in the four characters and (ii) the fourth character in the four characters are numerical digits.

4. The non-transitory computer-readable storage medium of claim 1, wherein the property information comprises at least one of a property description, an address, and media associated with the parcel of real property.

5. The non-transitory computer-readable storage medium of claim 4, wherein the media comprises at least one of one or more photographs and one or more videos.

6. The non-transitory computer-readable storage medium of claim 5, wherein the parcel of real property is under construction.

7. A non-transitory computer-readable storage medium, having instructions stored thereon that, when executed by a computing device, cause the computing device to perform operations, the operations comprising:
transmitting a graphical user interface (GUI) configured to permit a user to search a database, the database comprising a plurality of alphanumeric codes and information on a plurality of parcels of real property, wherein each of the plurality of alphanumeric codes is uniquely associated with one of the plurality of parcels of real property;
receiving a first alphanumeric code entered by the user;
retrieving the first alphanumeric code in the plurality of alphanumeric codes;
retrieving a first parcel of real property in the plurality of parcels that is associated with the first alphanumeric code; and
transmitting information on the first parcel of real property,
wherein each alphanumeric code in the plurality of alphanumeric codes has four characters,
wherein both (i) the first character in the four characters and (ii) the third character in the four characters are alphabetical letters, and
wherein both (i) the second character in the four characters and (ii) the fourth character in the four characters are numerical digits.

8. The non-transitory computer-readable storage medium of claim 7, wherein the information on the first parcel of real property comprises at least one of a property description, an address, and media associated with the parcel of real property.

9. The non-transitory computer-readable storage medium of claim 8, wherein the media comprises at least one of one or more photographs and one or more videos.

10. The non-transitory computer-readable storage medium of claim 9, wherein the first parcel of real property is under construction.

11. A method for displaying and retrieving information, the method comprising:
displaying a visual display comprising:
an alphanumeric code having a first through a fourth character, the first and the third characters being alphabetical letters, and the second and the fourth characters being numerical digits,
one or more products or services associated with the alphanumeric code,
generating, by at least one processor, a graphical user interface (GUI) that prompts a user to enter the alphanumeric code;
transmitting, by the at least one processor, the GUI to the user;
receiving, by the at least one processor, the alphanumeric code;
retrieving, by the at least one processor, information from a database relating to the one or more products or services associated with the alphanumeric code; and
transmitting, by the at least one processor, the information to the user.

12. The method of claim 11, wherein the one or more products or services comprise a parcel of real property that is under construction.

13. The method of claim 12, wherein the information comprises at least one of a description of the parcel of real property, an address of the parcel of real property, one or more photographs of the parcel of real property, and one or more videos of the parcel of real property.

14. The method of claim 11, further comprising:
transmitting, by the at least one processor, a prompt for the user to choose, as the alphanumeric code, either (i) a custom code generated by the user, or (ii) a randomly generated code;
when the user chooses to generate the custom code:
transmitting, by the at least one processor, a prompt for the user to input the custom code;
verifying, by the at least one processor, that the custom code is neither currently in use nor has been used for a predetermined past portion of time;
verifying, by the at least one processor, that the custom code conforms to one or more formatting requirements;
assigning, by the at least one processor, the custom code to the user;
when the user chooses the randomly generated code:
generating, by the at least one processor, the randomly generated code; and
assigning, by the at least one processor, the randomly generated code to the user.

15. The method of claim 11, wherein the visual display does not have a quick response (QR) code.

16. The method of claim 11, further comprising:
prompting, by the at least one processor, an individual to enter the information relating to the one or more products or services into the database; and
generating, by the at least one processor, the alphanumeric code.

17. The method of claim 13, further comprising:
generating a plurality of tables comprising a property types table, a property table, a customer table, a security questions table, and an invoice table.

18. The method of claim 17, wherein the property types table comprises data on types of real property in which the user is interested, and wherein the property table comprises the information and the alphanumeric code.

19. The method of claim 18, wherein the customer table comprises data relating to the user, the data comprising at least one of a name of the user, a residential address of the user, a telephone number of the user, and an e-mail address of the user, and wherein the security questions table comprises one or more security questions provided by the user and one or more answers to the one or more security questions.

20. The method of claim 19, wherein the invoice table comprises billing data, the billing data comprising at least one of a credit card number of the user, a billing address of the user, one or more billing amounts, and one or more dates corresponding to the one or more billing amounts.

21. The method of claim 12, further comprising determining a particular location of a client computing device using at least one of a cellular network, one or more wireless networks, and global positioning system (GPS) hardware to determine latitude and longitude coordinates of the client computing device and determining at least one parcel of real property that is under construction that is within a particular distance from the latitude and longitude coordinates of the client computing device.

22. The method of claim 21, further comprising displaying an indicator of the particular location of the client computing device and at least one graphical user interface element that represents each of the at least one parcel of real property on a map using WebGL.

23. The method of claim 22, wherein the at least one graphical user interface element that represents each of the at least one parcel of real property comprises the alphanumeric code.
